(19) United States
(12) Patent Application Publication
(10) Pub. No.: US 2009/0175253 A1
(43) Pub. Date: Jul. 9, 2009

(54) Frame format for random access response of wireless communication transmission

(75) Inventors: Chunli Wu, Beijing (CN); Li-Cheng Lin, Yilan City (TW); Chung-Shan Wang, Sinfong Township (TW); Tsung-Liang Lu, Taipei City (TW)

Correspondence Address: BACON & THOMAS, PLLC, 625 SLATERS LANE, FOURTH FLOOR, ALEXANDRIA, VA, 22314-1176, US

(73) Assignee: Sunplus mMobile Inc., Hsinchu Science Park (TW)

(21) Appl. No.: 12/318,636

(22) Filed: Jan. 5, 2009

Related U.S. Application Data
(60) Provisional application No. 61/006,348, filed on Jan. 8, 2008.
(60) Provisional application No. 61/064,702, filed on Mar. 21, 2008.

(51) Int. Cl. H04W 4/00

(52) U.S. Cl. 370/338

(57) ABSTRACT

A frame format for random access response of wireless communication transmission is provided. The frame format comprises a header segment and a variable length data segment. The header segment includes one or more random access response subheader and 0 to N load control subheader. The variable length data segment including one or more random access response data payload corresponding to the one or more random access response subheader. The one or more random access response subheader includes a status indication field to represent a last random access response subheader, a load control subheader, a random access response data payload with a T-CRNTI field, or a random access response data payload without a T-CRNTI field.

### CROSS-REFERENCE TO RELATED APPLICATION

This application claims the benefit of filing dates of U.S. Provisional Application Ser. No. 61/006,348, entitled “Enhanced Random Access Response Formats in E-UTRA” filed Jan. 8, 2008, and U.S. Provisional Application Ser. No. 61/064,702, entitled “Enhanced Random Access Response Format and Load Control Procedure in E-UTRA” filed Mar. 21, 2008 under 35 USC & 119(e)(1).

### BACKGROUND OF THE INVENTION

1. Field of the Invention

This invention relates generally to the technical field of wireless communication system and, more particularly, to a frame format for random access response of wireless communication transmission.

2. Description of Related Art

Various communications protocols are known in the art. For example, the Third Generation Partnership Project (3GPP) develops a number of protocols for use with a wireless communication path. The original scope of 3GPP wants to produce globally applicable technical specifications and technical reports for a 3rd generation and beyond mobile system based on evolved Global System for Mobile communication (GSM) core networks and the radio access technologies, including Universal Terrestrial Radio Access (UTRA) having both Frequency division duplex and time division duplex modes). 3GPP's scope was subsequently amended to include the maintenance and development of GSM technical specifications and technical reports having evolved radio access technologies (e.g. General Packet Radio Service (GPRS) and Enhanced Data rates for GSM Evolution (EDGE)).

Section 10.1.5 of 3GPP's Specification 36.300 describes, in part, a random access procedure and its' response. The random access procedure is performed for the following five events:

1. Initial access from RRC_IDLE;

2. RRC Connection Re-establishment procedure;

3. Handover;

4. DL data arrival during RRC_CONNECTED requiring random access procedure, for example: when UL synchronization status is “non-synchronized”; and

5. UL data arrival during RRC_CONNECTED requiring random access procedure, for example: when UL synchronization status is “non-synchronized” or there are no PUCCH resources for SR available.

Furthermore, the random access procedure takes two distinct forms:

1. Contention based (applicable to all five events); and

2. Non-contention based (applicable to only handover and DL data arrival).

The contention based and non-contention based random access procedures are shown in FIG. 1 and FIG. 2, respectively. No matter in the contention based or non-contention based random access procedures, the random access response format transmitted by the eNB is same and shown in FIG. 3.

As shown in FIG. 3, the header segment of the RA response is variable size and is consisted of one or more subheaders, each said subheader corresponds to a random access response except for the Backoff Indicator subheader. A subheader consists of the three subheader fields E/T/RAPID but for the Backoff Indicator subheader which consists of the five subheader fields E/T/R/R/BI. The RA response consists of the four fields R/TA/UL Grant/Temporary C-RNTI.

The R field is reserved. The E field of each subheader is a flag indicating if more subheaders are presented in the header segment or not. The E field is set to “1” to indicate another set of at least E/T/RAPID or E/T/R/R/BI fields. The E field is set to “0” to indicate that the RA response starts at the next byte.

The T field of each subheader is a flag indicating whether the subheader contains a Random Access ID or a Backoff Indicator. The T field is set to “0” to indicate the presence of a Backoff Indicator field in the subheader (BI). The T field is set to “1” to indicate the presence of a Random Access Preamble ID field in the subheader (RAPID).

The Backoff Indicator (BI) field identifies the overload condition in the cell. The size of the BI field is 4 bits. The Random Access Preamble IDentitfier (RAPID) field identifies the transmitted Random Access Preamble. The size of the RAPID field is 6 bits. The timing advance (TA) field indicates the required adjustment to the uplink transmission timing to be used for timing synchronization. The size of the TA field is 11 bits.

The UpLink Grant field indicates the resources to be used on the uplink. The size of the UL Grant field is 21 bits. The Temporary C-RNTI field indicates the temporary identity that is used by the UE during Random Access. The size of the Temporary C-RNTI field is 16 bits.

As E field is set to “1” and T field is set to “0”, it indicates the presence of a Backoff Indicator field in the subheader (BI) for load control and another subheader is following thereof. The Backoff Indicator is used in the UEs for avoiding congestion in wireless communication.

The header segment of RA (Random Access) response format could contain variable number of individual RA response subheader for different UEs, i.e. from 0 to n individual UEs. As E field is set to “1” and T field is set to “1”, it indicates that a Random Access Preamble ID field is present in the subheader (RAPID) and another subheader is following thereof. As E field is set to “0” and T field is set to “1”, it indicates the presence of a Random Access Preamble ID field in the subheader (RAPID) and no subheader following.

Regardless of the causes and situation of UE, all the three fields (TA, UL Grant, T-CRNTI) will be included in each individual RA response, though some of them are not needed, which will be waste of resources and bandwidth. Furthermore, overloading is not the often case for E-UTRA. using a separate T field in each subheader to indicate the back-off control will introduce redundancy.

Therefore, it is desirable to provide a new frame format for random access response of wireless communication transmission to mitigate and/or obviate the aforementioned problems.

### SUMMARY OF THE INVENTION

An object of the present invention is to provide a frame format for random access response of wireless communication transmission, which can reduce the number of bits used in the RA response to thereby reduce redundancy in wireless transmission.

Another object of the present invention is to provide a frame format for random access response of wireless communication transmission, which can dramatically reduce payload in the RA response to thereby reduce bandwidth and resource requirement in the prior art.

According to a feature of the invention, a frame format for random access response of wireless communication transmission is provided. The frame format comprises a header segment and a variable length data segment. The header segment includes one or more random access response subheader, one or more load control subheader, or one or more random access response subheader and one or more load control subheader. The variable length data segment includes one or more random access response data payload corresponding to the one or more random access response subheader. The one or more random access response subheader and one or more load control subheader respectively includes a status indication field, and the status indication field representing a last random access response subheader, a load control subheader, a random access response data payload with a T-CRNTI field, or a random access response data payload without a T-CRNTI field.

According to another feature of the invention, a frame format for random access response of wireless communication transmission is provided. The frame format comprises a header segment and a variable length data segment. The header segment includes one or more random access response subheader, one or more load control subheader, or one or more random access response subheader and one or more load control subheader. The variable length data segment includes one or more random access response data payload corresponding to the one or more random access response subheader. The one or more random access response subheader and one or more load control subheader respectively includes a status indication field, and the status indication field representing a last random access response subheader, a load control subheader, a random access response data payload with an UL grant field and a T-CRNTI field, or a random access response data payload without an UL grant field and a T-CRNTI field.

According to further feature of the invention, a frame format for random access response of wireless communication transmission is provided. The frame format comprises a header segment and a variable length data segment. The header segment includes one or more random access response subheader, one or more load control subheader, or one or more random access response subheader and one or more load control subheader. The variable length data segment includes one or more random access response data payload corresponding to the one or more random access response subheader. The one or more random access response data payload comprises a 0 to 1 T-CRNTI field representing an identification of user equipment, and a T-CRNTI field for determining by a dedicated user equipment preamble

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a contention based random access procedures;

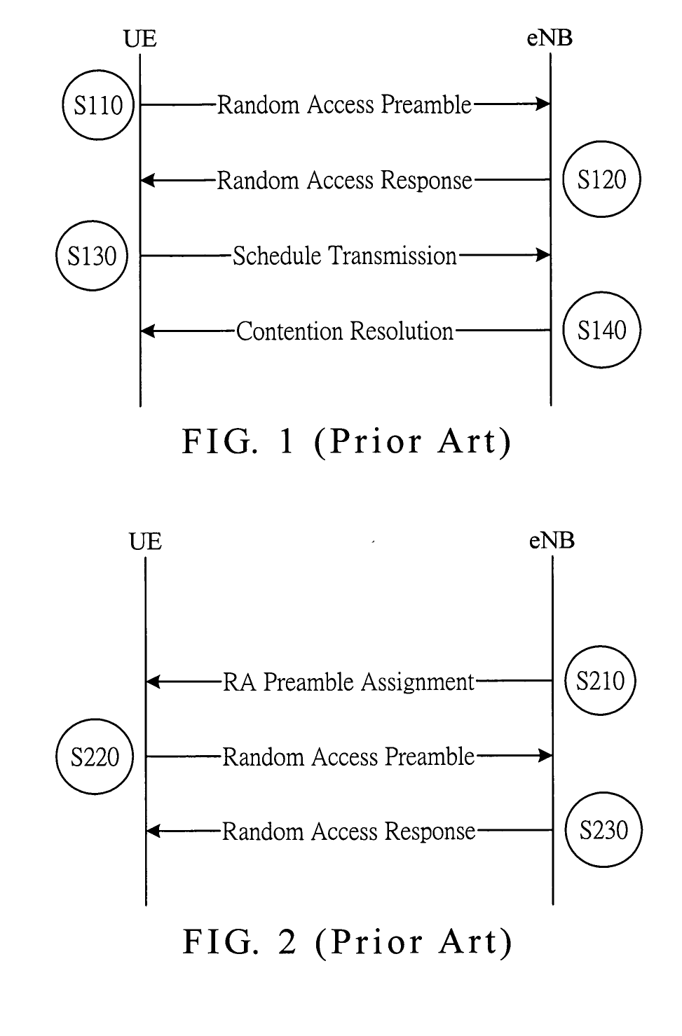

FIG. 2 is a schematic view of a non-contention based random access procedures;

FIG. 3 is a schematic view of a conventional frame format for random access response;

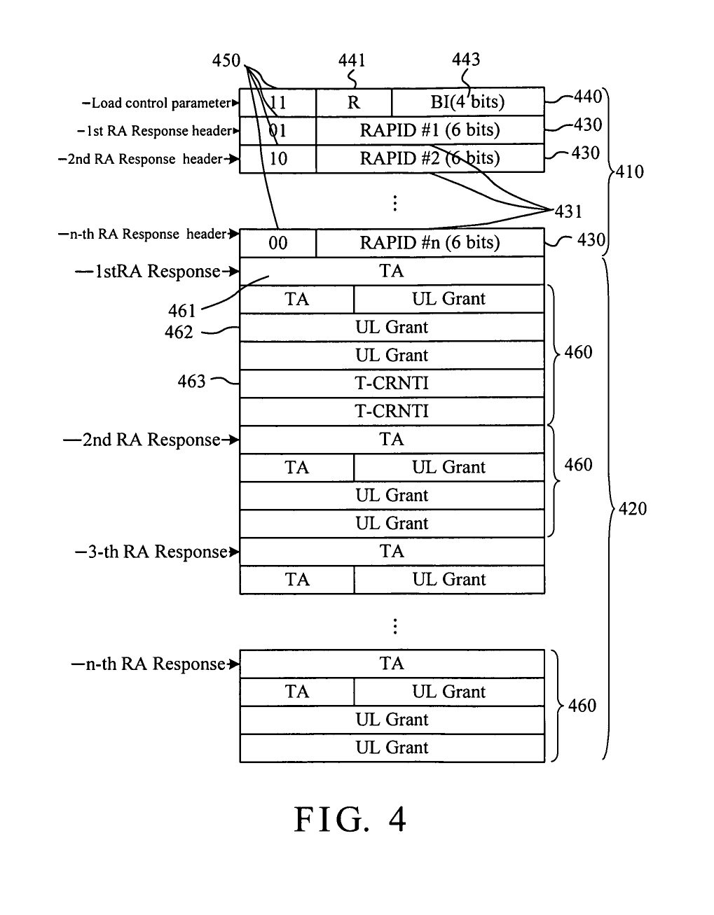

FIG. 4 is a schematic view of a frame format for random access response of wireless communication transmission in accordance with the invention;

FIG. 5 is a schematic view for the cause inducing random access;

FIG. 6 is a schematic view of usage profile in accordance with the invention;

FIG. 7 is a schematic view of the RA response in accordance with the invention;

FIG. 8 is another schematic view of a frame format for random access response of wireless communication transmission in accordance with the invention;

FIG. 9 is further schematic view of a frame format for random access response of wireless communication transmission in accordance with the invention;

FIG. 10 is further schematic view of a frame format for random access response of wireless communication transmission in accordance with the invention;

FIG. 11 and FIG. 12 are further schematic views which are combined the technology in FIG. 9 and FIG. 10 in accordance with the invention; and

FIG. 13 is further schematic view of a frame format for random access response of wireless communication transmission in accordance with the invention.

### DETAILED DESCRIPTION OF THE PREFERRED EMBODIMENT

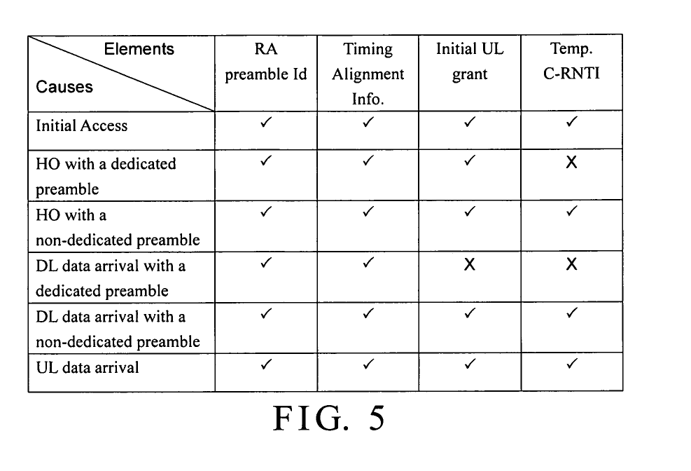

FIG. 4 is a schematic view of a frame format for random access response of wireless communication transmission in accordance with the invention. As shown in FIG. 4, frame format comprises a header segment 410 and a variable length data segment 420. The header segment 410 includes one or more random access response subheader 430 and 0 to N load control subheader 440.

The one or more random access response subheader 430 and the load control subheader 440 include a status indication field 450 to represent a last random access response subheader, a load control subheader, a random access response data payload 460 with a T-CRNTI field, or a random access response data payload 460 without a T-CRNTI field. In this embodiment, the size of the status indication field 450 is 2 bits. As status indication field 450 is set to “11”, it indicates that the subheader is a load control subheader 440 for load control and another subheader is following thereof.

As status indication field 450 is set to “00”, it indicates that the subheader is a last random access response subheader following with the data segment 420. The status indication field 450 is set to “01” for indicating the corresponding random access response data payload with a T-CRNTI field, and set to “01” for indicating the corresponding random access response data payload without a T-CRNTI field.

The one or more random access response subheader 430 further comprises a Random Access Preamble IDentitfier (RAPID) field 431 for identifying a user equipment preamble, wherein the RAPID field 431 has 6 bits. The load control subheader 440 further comprises a reserved field 441 and a load control field 443 to represent a backoff duration of user equipments in a service area of an E-UTRAN base station (eNB).

The variable length data segment 420 includes one or more random access response data payload 460 corresponding to the one or more random access response subheader 430. The one or more random access response data payload 460 is next to the one or more random access response subheader 430 with the status indication field 450 that indicates last random access response subheader, i.e. the status indication field 450 is set to “00”.

The one or more random access response data payload 460 comprises a timing advance (TA) field 461, an uplink grant (UL Grant) field 462, and 0 to 1 T-CRNTI field 463.

The timing advance (TA) field 461 represents the required adjustment to the uplink transmission timing for timing synchronization. The uplink grant (UL Grant) field 462 contains information that a user equipment can transmit by an uplink wireless channel. The T-CRNTI field 463 represents an identification of the user equipment, wherein when the status indication field 450 represents a random access response data payload with a T-CRNTI field, the one or more random access response data payload 460 includes one T-CRNTI field, and when the status indication field 450 represents a random access response data payload without a T-CRNTI field, the one or more random access response data payload 460 includes zero T-CRNTI field.

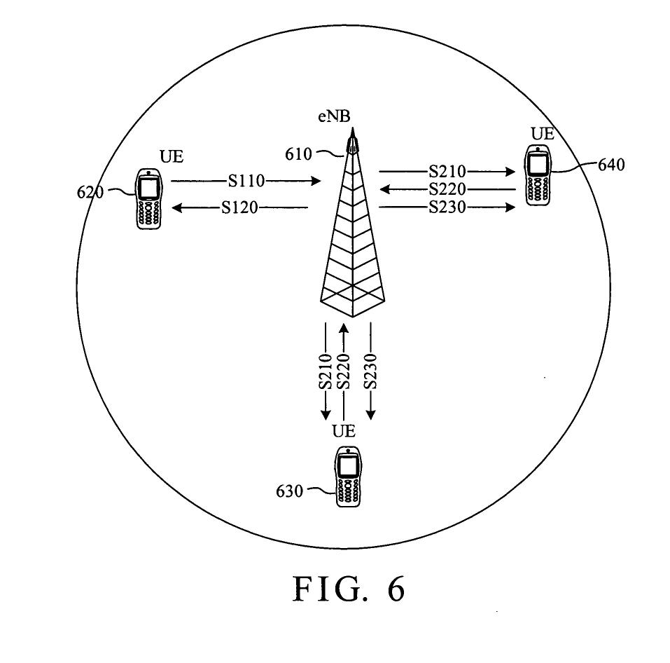

FIG. 5 is a schematic view for the cause inducing random access. As shown in FIG. 5, depending on the cause for random access, the Random Access Response may contain timing alignment, uplink grant, Temporary C-RNTI and RA preamble identifiers which are illustrated in FIG. 5, in which “v” indicates that the element is needed, and “x” indicates that the element is not needed and the UE will discard the un-need data. That is, as a UE in handover (HO) with a dedicated preamble or download (DL) data arrival with a dedicated preamble, the UE throw away the Temporary C-RNTI in the RA response. In accordance with the invention, eNB needs not to transmit the Temporary C-RNTI for UE in handover (HO) with a dedicated preamble or download (DL) data arrival with a dedicated preamble so as to dramatically reduce the size of the RA response and bandwidth of wireless channel, and increase the performance of whole system.

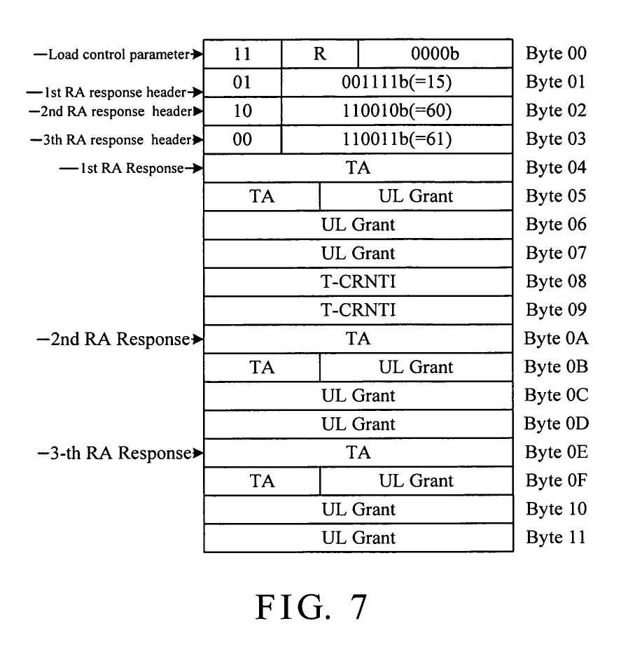

FIG. 6 is a schematic view of usage profile in accordance with the invention. The eNB will reserve some Random Access Preamble IDentitfier (RAPID) for dedicated RA such as non-contention based random access procedures, and the rest for contention based random access procedures. In this example, the eNB 610 reserves RAPID with 48-63 for non-contention based random access procedures and releases RAPID with 0-47 for non-contention based random access procedures. It is assumed that UE 620 is in initial access status, UE 630 is in handover status, and UE 640 is in DL data arrival with a dedicated preamble.

The UE 620 will choose randomly a RAPID having range of 0-47 as the Random Access Preamble for itself. For example, the UE 620 chooses a RAPID of 15 and sends a RA with RAPID 15 to the eNB 610.

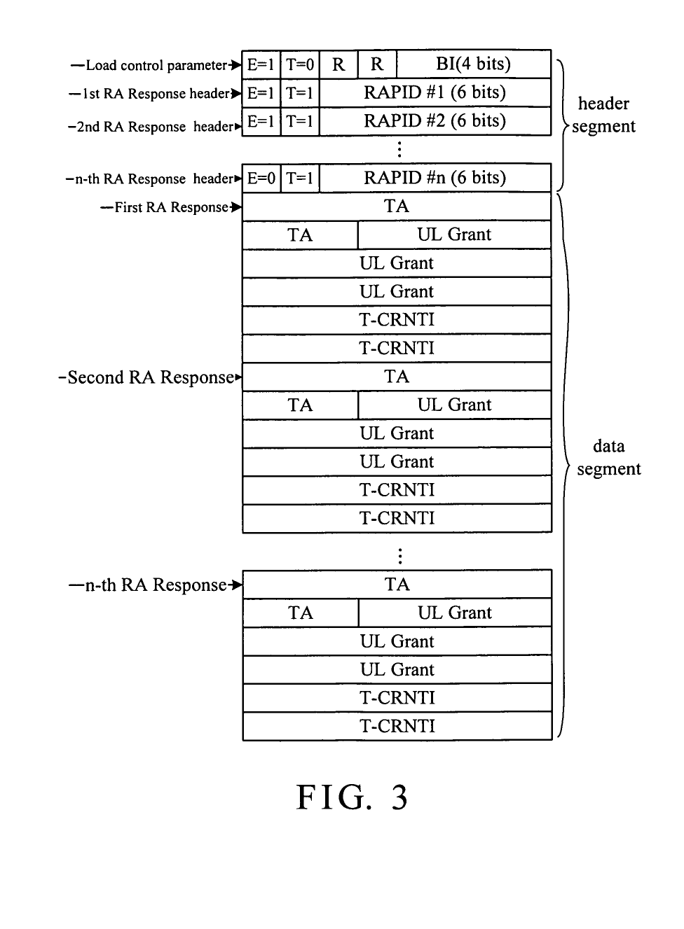

For handover operation, the eNB 610 firstly performs RA Preamble Assignment (step 210 in FIG. 2) for assigning a dedicate RAPID of 60 to the UE 630. Then, the UE 630 sends a RA preamble with RAPID of 60 to the eNB 610 which is the step S220 in FIG. 2. The same flow is also happened in the UE 640 which is assigned with a RAPID of 61 by the eNB 610 for download (DL) data arrival with a dedicated preamble (step 210 in FIG. 2).

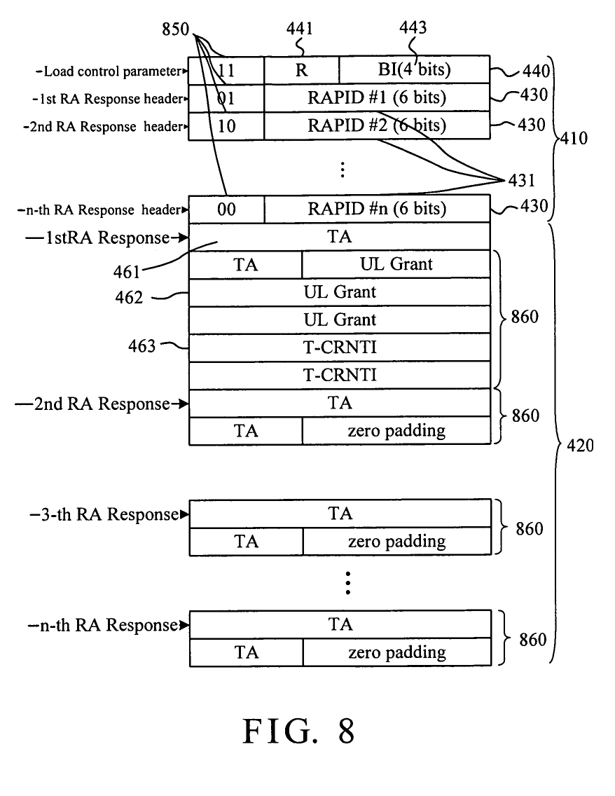

In the step S120 and step S230, the UE 620, UE 630, and UE 640 receives RA response transmitted by the eNB 610, respectively. FIG. 7 is a schematic view of the RA response in accordance with the invention. As UEs 620, 630, 640 read the status indication field 450 which is set to “11” in byte 00 of the RA response, UEs 620, 630, 640 recognize this subheader is a load control subheader 440 and there are subheaders following this subheader, and then read the load control field 443 for performing the Backoff operation. The load control field 443 is set to “0000b”, UEs 620, 630, 640 do not perform the Backoff operation.

UEs 620, 630, 640 read next byte (01) respectively, and identify that this subheader is for an RA response with T-CRNTI and is for UE whose preamble is equal to 15. UE 620 recognizes this random access response subheader 430 is for itself, but UE 620 needs to read following random access response subheader 430 for finding the corresponding random access response data payload 460.

UEs 620, 630, 640 read next byte (02) respectively, and identify that this subheader is for an RA response without T-CRNTI and is for UE whose preamble is equal to 60. UE 630 recognizes this random access response subheader 430 is for itself, and reads following random access response subheader 430.

UEs 620, 630, 640 read next byte (03) respectively, and identify that this subheader is the last random access response subheader 430 and is for UE whose preamble is equal to 61. UE 630 recognizes this random access response subheader 430 is for itself. The status indication field 450 is set to “00” in byte 03 of the RA response, UEs 620, 630, 640 recognize this subheader is the last random access response subheader 430 and the following is the data segment 420.

UE 620 reads byte 04-byte 09 in response to first RA response, and then performs a Schedule Transmission (Step S130) based on data in the T-CRNTI field 463. The 2nd and 3rd RA response headers are not for UE 620, and UE 620 can just skip the following data in the data segment 420.

UE 630 and UE 640 read byte 04-byte 09 in response to first RA response and discard what they read, or UE 630 and UE 640 can just skip byte 04-byte 09 based on the knowledge of the 1st RA Response subheader which is corresponding to a RA response with T-CRNTI and to UE with preamble 15.

UE 630 and UE 640 read byte 0A-byte 0D in response to 2nd RA response. With the assignment preamble 60 in step S210, UE 630 can perform subsequently operation. The 3rd RA response subheader is not for UE 630, and UE 630 can just skip the following data in the data segment 420. In another embodiment, UE 640 can just skip byte 0A-byte 0D based on the knowledge of the 2nd RA Response subheader which is corresponding to a RA response without T-CRNTI and to UE with preamble 60.

UE 640 read byte 0E-byte 11 in response to 3rd RA response. The status indication field 450 is set to “00” in byte 03 of the RA response, UE 640 can identify that there is no more data in the data segment 420.

This invention proposed a novel frame format for random access response to signal different elements in RA response messages for different cases such that the bandwidth requirement and data size of random access response can dramatically reduce.

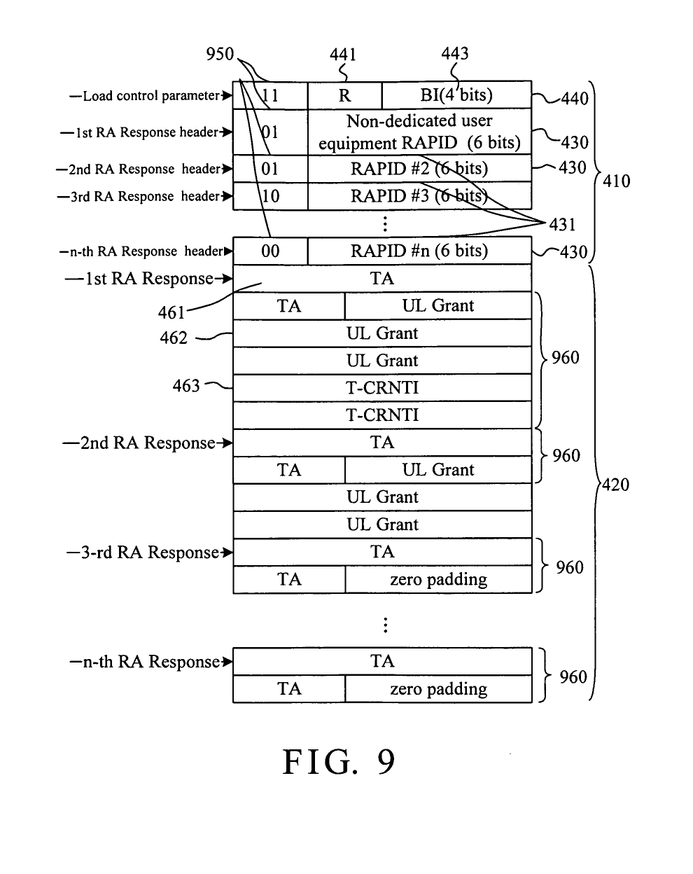

FIG. 8 is another schematic view of a frame format for random access response of wireless communication transmission in accordance with the invention. As shown in FIG. 8, frame format in FIG. 8 is same as frame format in FIG. 4 except the status indication field 850 and one or more random access response data payload 860.

As status indication field 850 is set to “11”, it indicates the subheader is a the load control subheader 440 which is used for load control and another subheader is following thereof. As status indication field 850 is set to “00”, it indicates that the subheader is a last random access response subheader following with the data segment 420. The status indication field 850 is set to “01” for indicating the corresponding random access response data payload with an UL grant field and a T-CRNTI field, and set to “10” for indicating the corresponding random access response data payload without the UL grant field and the T-CRNTI field.

The one or more random access response data payload 860 comprises a timing advance (TA) field 461, and 0 to 1 uplink grant (UL Grant) field 462 and T-CRNTI field 463.

As status indication field 850 is set to “01”, the one or more random access response data payload 860 comprises one UL Grant field 462 and one T-CRNTI field 463. As status indication field 850 is set to “10”, the one or more random access response data payload 860 does not comprise UL Grant field 462 and T-CRNTI field 463.

From FIG. 5, it is known that not all the UE need data in the T-CRNTI field or in the UL Grant field. For example, as a UE in hand over, the data in the T-CRNTI field of the RA response will be discarded by the UE with the corresponding information. Moreover, for an UE in download (DL) data arrival with a dedicated preamble, the UE can discard not only the data in T-CRNTI field 463, but also the data in UL Grant field 462.

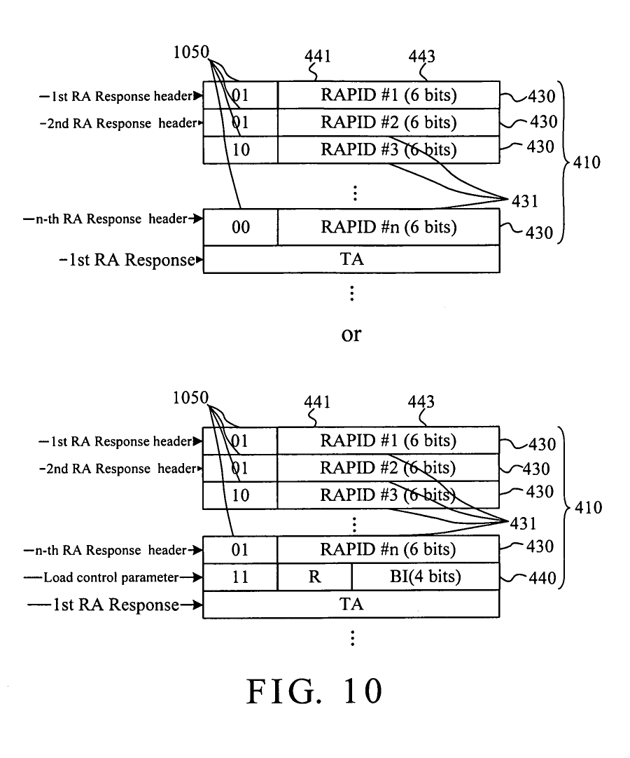

FIG. 9 is further schematic view of a frame format for random access response of wireless communication transmission in accordance with the invention. As shown in FIG. 9, frame format in FIG. 9 is same as frame format in FIG. 4 except the status indication field 950 and one or more random access response data payload 960.

As status indication field 950 is set to “11”, it indicates the subheader is a load control subheader 440 for load control and another subheader is following thereof. As status indication field 950 is set to “00”, it indicates that the subheader is a last random access response subheader following with the data segment 420. The status indication field 950 is set to “01” for indicating the corresponding random access response data payload with an UL grant field, and set to “10” for indicating the corresponding random access response data payload without an UL grant field.

The one or more random access response data payload 960 comprises a timing advance (TA) field 461, and a 0 to 1 uplink grant (UL Grant) field 462 and a T-CRNTI field 463.

As status indication field 950 is set to “01”, the one or more random access response data payload 960 comprises one UL Grant field 462. As status indication field 950 is set to “10”, the one or more random access response data payload 960 does not comprise UL Grant field 462. The random access response data payload 960 with/without the T-CRNTI field 463 is determined by a dedicated user equipment preamble. When the random access response data payload 960 is sent to an UE with a non-dedicated user equipment RAPID indicated in the corresponding random access response subheader, the random access response data payload 960 includes the T-CRNTI field 463, otherwise the random access response data payload 960 does not include the T-CRNTI field 463.

As shown in FIG. 9, the 1^{st}, 2^{nd}, 3^{rd} RA response are transmitted for UE 620, UE 630 and UE 640, respectively. As the UE 630 in hand over, the status indication field 950 is set to “01” and the eNB will transmit an RA response without the T-CRNTI field 463.

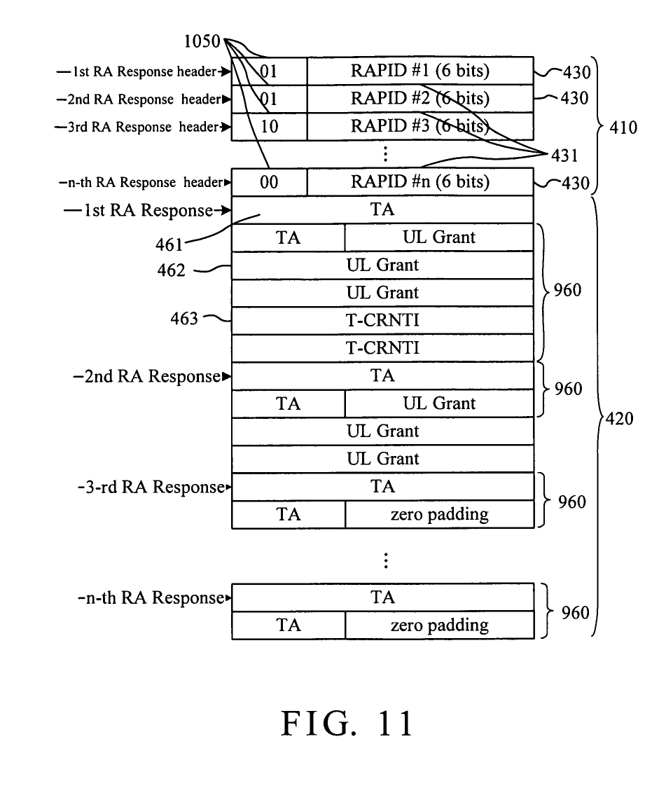

FIG. 10 is further schematic view of a frame format for random access response of wireless communication transmission in accordance with the invention. As shown in FIG. 10, frame format in FIG. 10 is same as frame format in FIG. 4 except the status indication field 1050.

As status indication field 1050 is set to “11”, it indicates the subheader is a load control subheader 440 which is used for load control and the subheader is a last subheader following with the data segment 420. As status indication field 1050 is set to “00”, it indicates that the subheader is a last random access response subheader following with the data segment 420. The status indication field 1050 is set to “01” for indicating the corresponding random access response data payload with a T-CRNTI field, and set to “01” for indicating the corresponding random access response data payload without the T-CRNTI field.

In the header segment 410, it only contains one subheader, the load control subheader 440 with status indication field 1050 is set to “11” or the last random access response subheader with status indication field 1050 is set to “00”, for indicating the last subheader following with the data segment 420. That is, the load control subheader 440 with status indication field 1050 set to “11” and the last random access response subheader with status indication field 1050 set to “00” are mutually exclusive, and one and only one can be presented in the header segment 410.

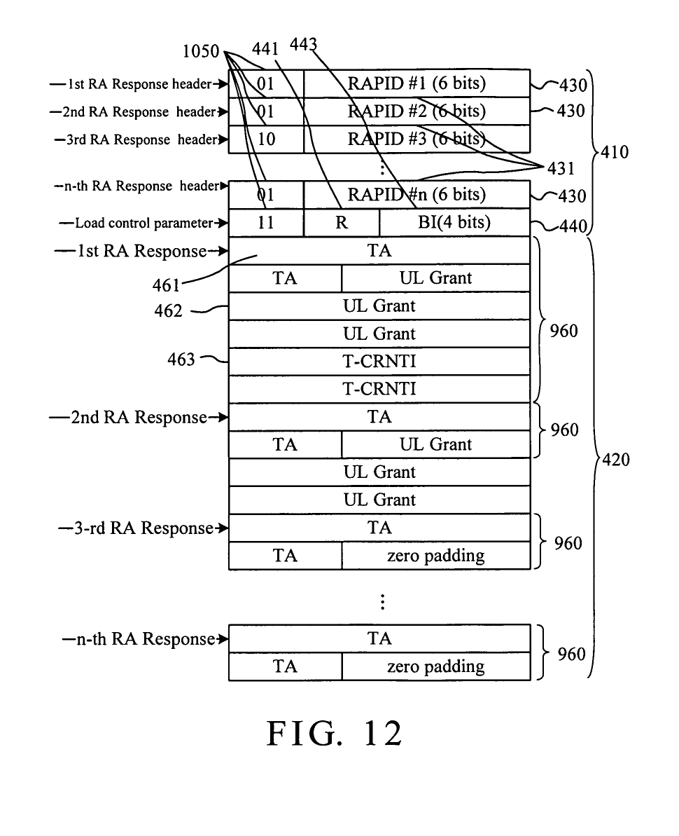

FIG. 11 and FIG. 12 are further schematic views of a frame format for random access response of wireless communication transmission in accordance with the invention, which are combined the technology in FIG. 9 and FIG. 10. As shown in FIG. 11 and FIG. 12, the header segment 410 only contains one subheader, wherein the last random access response subheader with status indication field 1050 is set to “00” or the load control subheader 440 with status indication field 1050 is set to “11”, for indicating the last subheader following with the data segment 420. That is, the load control subheader 440 with status indication field 1050 is set to “11” and the last random access response subheader with status indication field 1050 is set to “00” are mutually exclusive, and one and only one can be presented in the header segment 410.

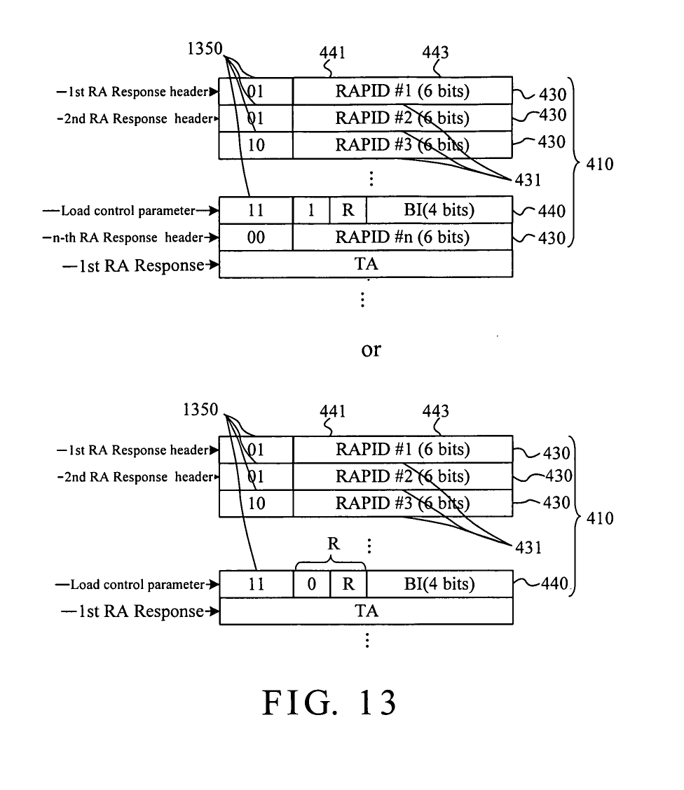

FIG. 13 is further schematic view of a frame format for random access response of wireless communication transmission in accordance with the invention. As shown in FIG. 13, frame format in FIG. 13 is same as frame format in FIG.4 except the status indication field 1350.

As status indication field 1350 is set to “11” and one reserved bit is set to “0”, it indicates the subheader is a load control subheader 440 for load control, and the subheader is a last subheader following with the data segment 420. As status indication field 1350 is set to “00”, it indicates that the subheader is a last random access response subheader following with the data segment 420. The status indication field 1350 is set to “01” for indicating the corresponding random access response data payload with a T-CRNTI field, and set to “01” for indicating the corresponding random access response data payload without the T-CRNTI field.

As shown in FIG. 13, it is known that the load control subheader 440 with status indication field 1350 is set to “11” and one reserved bit is set to “1” can be co-existed with the last random access response subheader with status indication field 1050 is set to “00” in the header segment 410, and the load control subheader 440 with status indication field 1050 is set to “11” and one reserved bit is set to “0” can not be co-existed with the last random access response subheader with status indication field 1050 is set to “00” in the header segment 410.

As cited, the typical RA response format does not consider the aforementioned situation, and there is no an optimum solution for the typical RA response. Instead, the invention provides a novel mechanism to signal back-off control and different elements in RA response messages for different cases. In the invention, the eNB transmits the RA response based on the status of the UEs such that the data size of the RA response and redundancy in the RA response can reduce dramatically, thus reducing bandwidth and resource requirement in the prior art.

Although the present invention has been explained in relation to its preferred embodiment, it is to be understood that many other possible modifications and variations can be made without departing from the spirit and scope of the invention as hereinafter claimed.

What is claimed is:

1. A frame format for random access response of wireless communication transmission, comprising:
a header segment, including one or more random access response subheader, one or more load control subheader, or one or more random access response subheader and one or more load control subheader; and
a variable length data segment, including one or more random access response data payload corresponding to the one or more random access response subheader;
wherein the one or more random access response subheader and the one or more load control subheader respectively includes a status indication field, the status indication field representing a last random access response subheader, a load control subheader, a random access response data payload with a T-CRNTI field, or a random access response data payload without the T-CRNTI field.

2. The frame format of claim 1, wherein the one or more random access response subheader further comprises:
a random access identification field, to identify a user equipment (UE) preamble.

3. The frame format of claim 1, wherein the one or more load control subheader comprises:
a load control field, to represent a backoff duration of user equipment in a service area of E-UTRAN base station.

4. The frame format of claim 1, wherein the one or more random access response data payload is next to the one or more random access response subheader with the status indication field for indicating the last random access response subheader.

5. The frame format of claim 1, wherein the one or more random access response data payload comprises:
a timing advance field, to represent the timing adjustment that user equipment has to apply;
an uplink grant field, to contain information relating to the transmit of user equipment by uplink wireless channel; and
a 0 to 1 T-CRNTI field, to represent an identification of the user equipment;
wherein when the status indication field represents the random access response data payload with the T-CRNTI field, the one or more random access response data payload includes single the T-CRNTI field, and when the status indication field represents the random access response data payload without the T-CRNTI field, the one or more random access response data payload includes zero the T-CRNTI field.

6. A frame format for random access response of wireless communication transmission, comprising:
a header segment, including one or more random access response subheader, one or more load control subheader, or one or more random access response subheader and one or more load control subheader; and
a variable length data segment, including one or more random access response data payload corresponding to the one or more random access response subheader;
wherein the one or more random access response subheader and one or more load control subheader respectively includes a status indication field for representing a last random access response subheader, a load control subheader, a random access response data payload with an UL grant field and a T-CRNTI field, or a random access response data payload without the UL grant field and the T-CRNTI field.

7. The frame format of claim 6, wherein the one or more random access response subheader further comprises:
a random access identification field, to identify an user equipment preamble.

8. The frame format of claim 6, wherein the one or more load control subheader comprises:
a load control field, to represent a backoff duration of user equipment in a service area of E-UTRAN base station.

9. The frame format of claim 6, wherein the one or more random access response data payload is next to the one or more random access response subheader with the status indication field for indicating last random access response subheader.

10. The frame format of claim 6, wherein the one or more random access response data payload comprises:
a timing advance field, to represent the timing adjustment that an user equipment has to apply; and
a 0 to 1 UL grant and T-CRNTI field, to represent information relating to transmit of user equipment by uplink wireless channel and an identification of the user equipment;
wherein when the status indication field represents the random access response data payload with the UL grant field, the one or more random access response data payload includes single the UL grant field and single the T-CRNTI field, and when the status indication field represents the random access response data payload without the UL grant field, the one or more random access response data payload includes zero the UL grant field and single said T-CRNTI field.

11. The frame format of claim 8, wherein the one or more random access response data payload is next to the one or more load control subheader.

12. A frame format for random access response of wireless communication transmission, comprising:
a header segment, including one or more random access response subheader, one or more load control subheader, or one or more random access response subheader and one or more load control subheader; and
a variable length data segment, including one or more random access response data payload corresponding to the one or more random access response subheader;
wherein the one or more random access response data payload comprises a 0 to 1 T-CRNTI field representing an identification of user equipment, and a T-CRNTI field for determining by a dedicated user equipment preamble.

13. The frame format of claim 12, wherein when the one or more random access response is corresponding to the dedicated user equipment preamble, the one or more random access response data payload includes one said T-CRNTI field, and when the one or more random access response is corresponding to a non-dedicated user equipment preamble, the one or more random access response data payload includes zero said T-CRNTI field.

14. The frame format of claim 12, wherein the one or more random access response subheader and one or more load control subheader respectively includes a status indication field for representing a last random access response subheader, a load control subheader, a random access response data payload with UL grant field, or a random access response data payload without the UL grant field.

15. The frame format of claim 12, wherein the one or more random access response subheader further comprises a random access identification field to identify an user equipment preamble, and the load control subheader comprises a load control field to represent a backoff duration of user equipment in a service area of E-UTRAN base station.

16. The frame format of claim 12, wherein the one or more random access response data payload is next to the one or more random access response subheader with the status indication field for indicating last random access response subheader.

17. The frame format of claim 16, wherein the one or more random access response data payload comprises:
a timing advance field, to represent the timing adjustment that user equipment has to apply; and
a 0 to 1 UL grant field, to represent information relating to transmit of the user equipment by uplink wireless channel;
a 0 to 1 T-CRNTI field, to represent information relating to an identification of the user equipment;
wherein when the status indication field represents the random access response data payload with UL grant field, the one or more random access response data payload includes one said UL grant, and when the status indication field represents the random access response data payload without the UL grant field, the one or more random access response data payload includes zero said UL grant field.

18. The frame format of claim 15, wherein the one or more random access response data payload is next to the one or more load control subheader.
